(19) United States
(12) Patent Application Publication
(10) Pub. No.: US 2015/0343313 A1
(43) Pub. Date: Dec. 3, 2015

(54) USER ENFORCEMENT REPUTATION SCORING ALGORITHM & AUTOMATED DECISIONING AND ENFORCEMENT SYSTEM FOR NON-EVIDENCE SUPPORTED COMMUNICATIONS MISCONDUCT

(71) Applicant: Microsoft Corporation, Redmond, WA (US)

(72) Inventors: Glenn Kaleta, Bothell, WA (US); Kailas Bobade, Redmond, WA (US); Andreas Holbrook, Redmond, WA (US)

(73) Assignee: Microsoft Corporation, Redmond, WA (US)

(21) Appl. No.: 14/291,999

(22) Filed: May 30, 2014

(51) Int. Cl. A63F 13/79

(52) U.S. Cl. CPC A63F 13/79

(57) ABSTRACT

A method of determining an enforcement reputation of a first user of a multi-player computer-based game includes collecting values for a plurality of parameters each indicative of a first user's ability to report unacceptable conduct of other users who have participated in one or more game sessions with the first user and indicative of a likelihood that the first user has participated in unacceptable conduct. An enforcement accuracy score and an enforcement risk score are assigned to the first user based on the values of the plurality of parameters collected for the first user. The accuracy score reflects the first user's ability to report unacceptable conduct of the other users and the enforcement risk score reflects the likelihood that the first user has participated in unacceptable conduct.

### BACKGROUND

In a typical online session, such as virtual reality sessions and those involving games, and other applications, users may interact and communicate with other online users in the online community. During this interaction, the members of the online community may be subjected to inappropriate or offensive behavior from other members of the community. Such behavior may violate a code of conduct that all community members agree to abide by in order to participate in the online session.

For example, one community member may begin sending chat messages that include profane or other inappropriate language to other members of the community. Likewise, one member of the community may make obscene gestures or drawings that are visible to the other community members. In addition, a community member may engage in illegal conduct. In another example, during an online game one or more game players may engage in cheating to take an unfair advantage over the other game players. The cheating activity can lead to dissatisfaction with the online game by the other online game players.

Offensive, illegal, cheating, or other inappropriate actions by particular community members can decrease the enjoyment of the online session for the other community members. Thus, enforcement mechanisms may be used to penalize community members who are involved in inappropriate conduct. For example, community members who have been found to violate the code of conduct may be suspended from participating in an online session for a specified period of time.

### SUMMARY

In one implementation, a system and method is described for determining enforcement reputation scores for online game players, which may be used to respond to complaints by one or more players against another player. These scores may be used in circumstances in which it is difficult to verify the accuracy of the complaint, thereby making it difficult to determine if the complainant should be penalized. The enforcement reputation scores are composed of two components, an enforcement accuracy score, which reflects the complainer's ability to accurately report unacceptable conduct and an enforcement risk score, which reflects the likelihood that the complainant actually engaged in unacceptable conduct.

In one particular implementation, a user's enforcement reputation score may be determined from values of a number of different parameters. For example, such parameters may include one or more of the following: the number of incoming complaints submitted against the user, the number of accurate complaints submitted against the user, the user's tenure on the service, the number of enforcement actions taken against the user, the number of complaints the user files, the number of complaints that a user files that result in enforcement actions, the number of offensive words used by a user in communications with other users and the number of mutes and blocks issued against the user by other users.

This summary is provided to introduce simplified concepts for managing an immerse environment that are further described below in the Detailed Description. This summary is not intended to identify essential features of the claimed subject matter, nor is it intended for use in determining the scope of the claimed subject matter.

### BRIEF DESCRIPTION OF THE DRAWINGS

FIG. 1 is diagram of an exemplary computer network that serves to illustrate aspects of systems and methods for determining enforcement reputation scores for online game players.

FIG. 2 illustrates the functional components of a multimedia/gaming console that can be used as one or more of the client devices shown in FIG. 1.

FIG. 3 illustrates an exemplary architecture that can be used to implement systems and methods for determining enforcement reputation scores for online game players or other users.

FIGS. 4A-4E illustrate one example of a user interface (UI) for a feedback mechanism whereby a game player can provide feedback on other game players, the feedback including the filing of a complaint.

FIG. 5 is a flowchart illustrating one example of a method of determining an enforcement reputation score of for users of a multi-player computer-based game and using that score to respond to a complaint submitted against a first user by another user.

### DETAILED DESCRIPTION

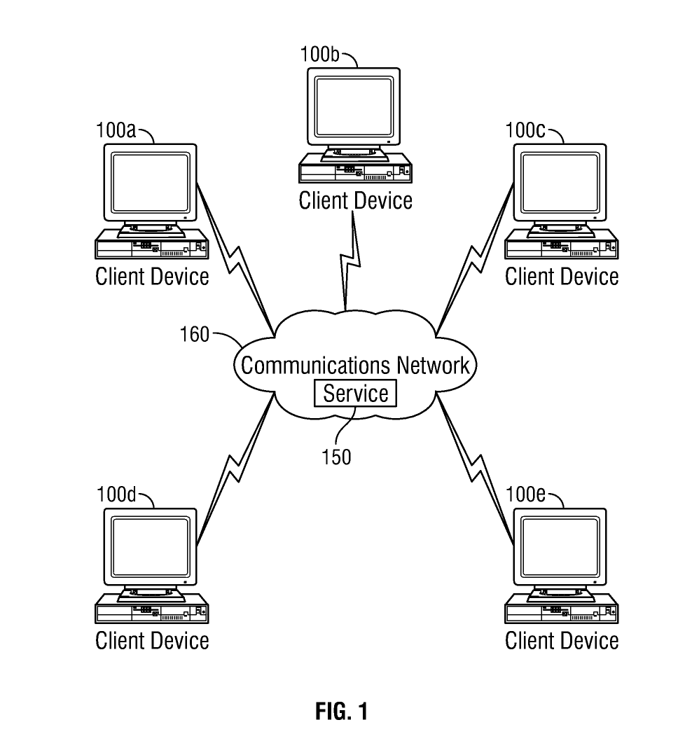

FIG. 1 is diagram of an exemplary computer network that serves to illustrate aspects of systems and methods for determining enforcement reputation scores for online game players, which may be used to respond to complaints by one or more players against another player. Here client devices 100a-100e can host various ones of the computing objects such as games and other applications. Although the physical environment shows the connected devices as computers, such illustration is merely exemplary and can comprise various digital devices such as game consoles, smartphones, personal computers, laptops, tablets, PDAs, etc. Moreover, communications network 160 can itself comprise a number of computers, servers and network devices such as routers and the like.

There is a variety of systems, components, and network configurations that support distributed computing environments. For example, computing systems can be connected together by wireline or wireless systems, by local networks or widely distributed networks. Currently, many of the networks are coupled to the Internet which provides the infrastructure for widely distributed computing and encompasses many different networks. Aspects of reputation determination of an online game player could be usable to distribute computer-readable instructions, code fragments, applications and the like to various distributed computing devices.

Clients and servers communicate with one another utilizing the functionality provided by a protocol layer. For example, Hypertext-Transfer Protocol (HTTP) is a common protocol that is used in conjunction with the World Wide Web (WWW) or, simply, the “Web.” Typically, a computer network address such as a Uniform Resource Locator (URL) or an Internet Protocol (IP) address is used to identify the server or client devices to each other. Communication among computing devices is provided over a communications medium. For instance, the client and server can be coupled to one another via TCP/IP connections for high-capacity communication.

In general, the computer network can comprise both server devices and client devices deployed in a network environment (in a peer-to-peer environment devices can be both clients and servers). Communications network 160 can be a LAN, WAN, intranet or the Internet, or a combination of any of these that facilitates communication among a number of computing devices 100a-100e. Moreover, communication network 160 can comprise wireless, wireline, or combination wireless and wireline connections. Additionally, the computer network can comprise a distributed computing environment. In such an environment a computing task can be spread over a number of computing devices that are addressable elements in a computer network.

According to an aspect of the enforcement reputation determination systems and methods, communication network 160 can host a service 150 that is accessible from the plurality of client devices 100a-100e. The service 150 gathers information and tracks users of client devices 100a-100e to provide computing services for all of the users of the service.

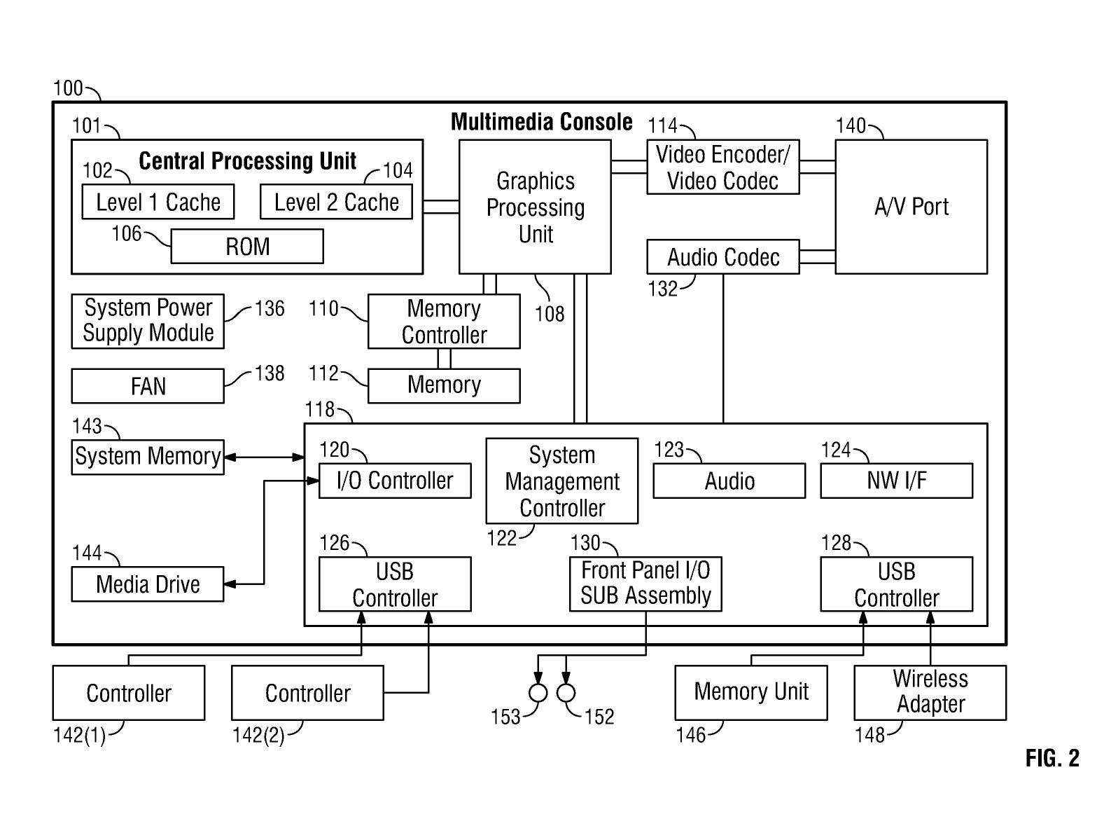

FIG. 2 illustrates the functional components of a multimedia/gaming console 100 that can be used as one or more of the client devices 100a-100e in the network of FIG. 1. The multimedia console 100 has a central processing unit (CPU) 101 having a level 1 cache 102, a level 2 cache 104, and a flash ROM (Read Only Memory) 106. The level 1 cache 102 and a level 2 cache 104 temporarily store data and hence reduce the number of memory access cycles, thereby improving processing speed and throughput. The CPU 101 can be provided having more than one core, and thus, additional level 1 and level 2 caches 102 and 104. The flash ROM 106 can store executable code that is loaded during an initial phase of a boot process when the multimedia console 100 is powered ON.

A graphics processing unit (GPU) 108 and a video encoder/video codec (coder/decoder) 114 form a video processing pipeline for high speed and high resolution graphics processing. Data is carried from the graphics processing unit 108 to the video encoder/video codec 114 via a bus. The video processing pipeline outputs data to an A/V (audio/video) port 140 for transmission to a television or other display. A memory controller 110 is connected to the GPU 108 to facilitate processor access to various types of memory 112, such as, but not limited to, a RAM (Random Access Memory).

The multimedia console 100 includes an I/O controller 120, a system management controller 122, an audio processing unit 123, a network interface controller 124, a first USB host controller 126, a second USB controller 128 and a front panel I/O subassembly 130 that are preferably implemented on a module 118. The USB controllers 126 and 128 serve as hosts for peripheral controllers 142(1)-142(2), a wireless adapter 148, and an external memory device 146 (e.g., flash memory, external CD/DVD ROM drive, removable media, etc.). The network interface 124 and/or wireless adapter 148 provide access to a network (e.g., the Internet, home network, etc.) and can be any of a wide variety of various wired or wireless adapter components including an Ethernet card, a modem, a Bluetooth module, a cable modem, and the like.

System memory 143 is provided to store application data that is loaded during the boot process. A media drive 144 is provided and can comprise a DVD/CD drive, hard drive, or other removable media drive, etc. The media drive 144 can be internal or external to the multimedia console 100. Application data can be accessed via the media drive 144 for execution, playback, etc. by the multimedia console 100. The media drive 144 is connected to the I/O controller 120 via a bus, such as a Serial ATA bus or other high speed connection (e.g., IEEE 1394).

The system management controller 122 provides a variety of service functions related to assuring availability of the multimedia console 100. The audio processing unit 123 and an audio codec 132 form a corresponding audio processing pipeline with high fidelity and stereo processing. Audio data is carried between the audio processing unit 123 and the audio codec 132 via a communication link. The audio processing pipeline outputs data to the A/V port 140 for reproduction by an external audio player or device having audio capabilities.

The front panel I/O subassembly 130 supports the functionality of the power button 153 and the eject button 152, as well as any LEDs (light emitting diodes) or other indicators exposed on the outer surface of the multimedia console 100. A system power supply module 136 provides power to the components of the multimedia console 100. A fan 138 cools the circuitry within the multimedia console 100.

The CPU 101, GPU 108, memory controller 110, and various other components within the multimedia console 100 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 100 is powered ON, application data can be loaded from the system memory 143 into memory 112 and/or caches 102, 104 and executed on the CPU 101. The application can present a graphical user interface that provides a consistent user experience when navigating to different media types available on the multimedia console 100. In operation, applications and/or other media contained within the media drive 144 can be launched or played from the media drive 144 to provide additional functionalities to the multimedia console 100.

The multimedia console 100 can be operated as a standalone system by simply connecting the system to a television or other display. In this standalone mode, the multimedia console 100 allows one or more users to interact with the system, watch movies, or listen to music. However, with the integration of broadband connectivity made available through the network interface 124 or the wireless adapter 148, the multimedia console 100 can further be operated as a participant in the larger network community as illustrated in FIG. 1.

According to an aspect of reputation determination, when a game is executed on console 100, it provides information to a service operating on communications network 160. The service tracks the information for all of the users connected to the service to provide a rich user experience. The service tracks user information across games, consoles, client devices, etc. By tracking the information for all users of the service, the service can aggregate statistics for all users and measure game playing ability, provide a richer user experience by providing information about friends (e.g., what game they are playing and what skill level they have attained), track user achievements and generally measure statistics for a game aggregated over a large user community.

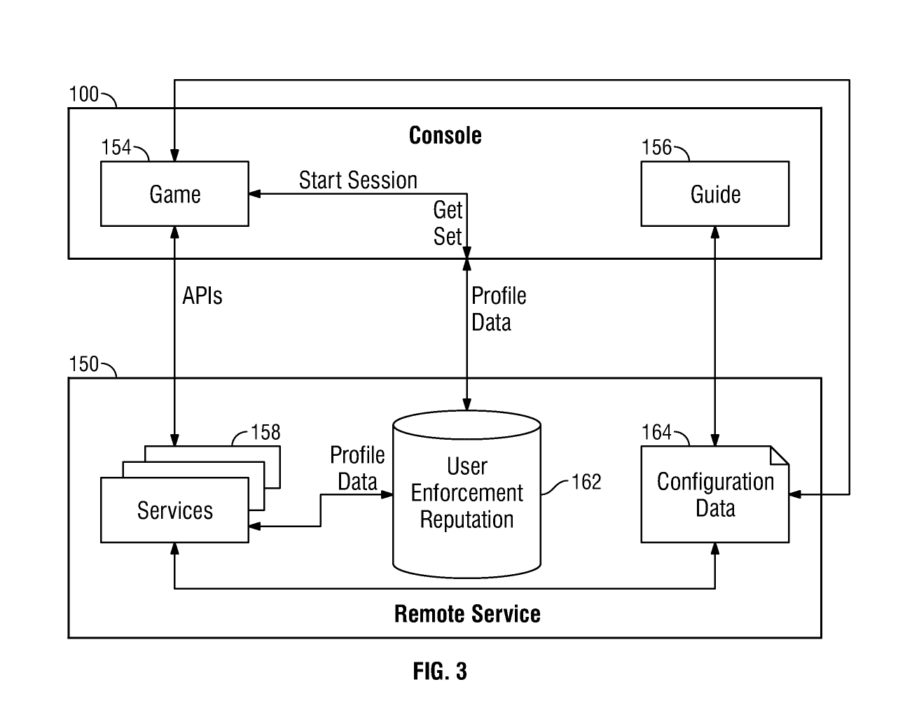

Referring to FIG. 3, there is illustrated an overview of an exemplary architecture that can be used to implement systems and methods for determining enforcement reputation scores for online game players or other users. The console 100 interacts with a remote service 150 that provides services 158 such as voice/chat, a friends list, matchmaking, content download, roaming, feedback, tournaments, voice messaging, and updates to gamers. The service 150 also maintains the user enforcement reputation scores in a database 162 and configuration data 164 used by the services 158 and games 154. The service 150 collects user enforcement reputation scores, aggregates and processes information supplied by other services 158. Using the console 100, the user can interact with a guide 156. The guide 156 provides an interface where the user can navigate to, and enter, various online areas and options provided by the service 158. The service 150 can provide users with game statistics, game achievements, affiliations, game settings, etc.

In some implementations the service 150 maintains the user enforcement reputation scores as one component of a user profile that represents the entirety of information (e.g., metadata) related to a specific user (i.e., the game player's digital identity). The user profile is developed from a set of services that collect and expose this information in a meaningful way to the larger community of users. The user profile may also provide for personalization such that users can customize and enhance their gaming experience. In addition to the user enforcement reputation scores, the user profile may include various other components, including, but not limited to, game achievements, user entered biographic text and preferences.

Using the console 100, the user can interact with a guide 156. The guide 156 provides an interface where the user can navigate to, and enter, various online areas and options provided by the service 158. When requesting User Profile information, the game 154 can pass a unique identifier of a user. The service 150 can return a Gamercard (discussed below), game stats, game achievements, affiliations, game settings. etc. Additional details of the various aspects of the exemplary architecture are provided below.

One function performed by the service 150 is the enforcement of a code of conduct, which, among other things, specifies the types of conduct that are unacceptable from users of the service. Such unacceptable conduct is often conduct that is offensive to other users participating in a game session. Of course, other types of conduct also may be deemed unacceptable in the accordance with the code of conduct. In some cases unacceptable conduct can be categorized as being either unacceptable communication or unacceptable behavior.

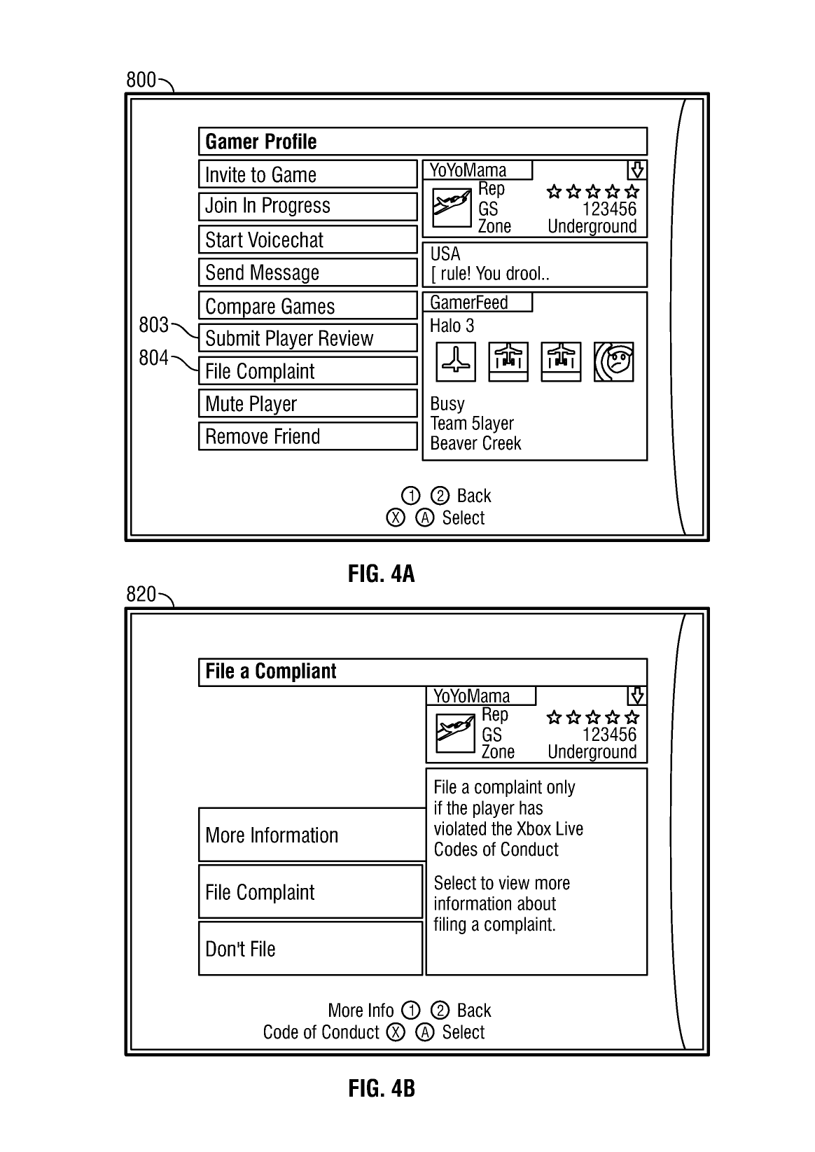

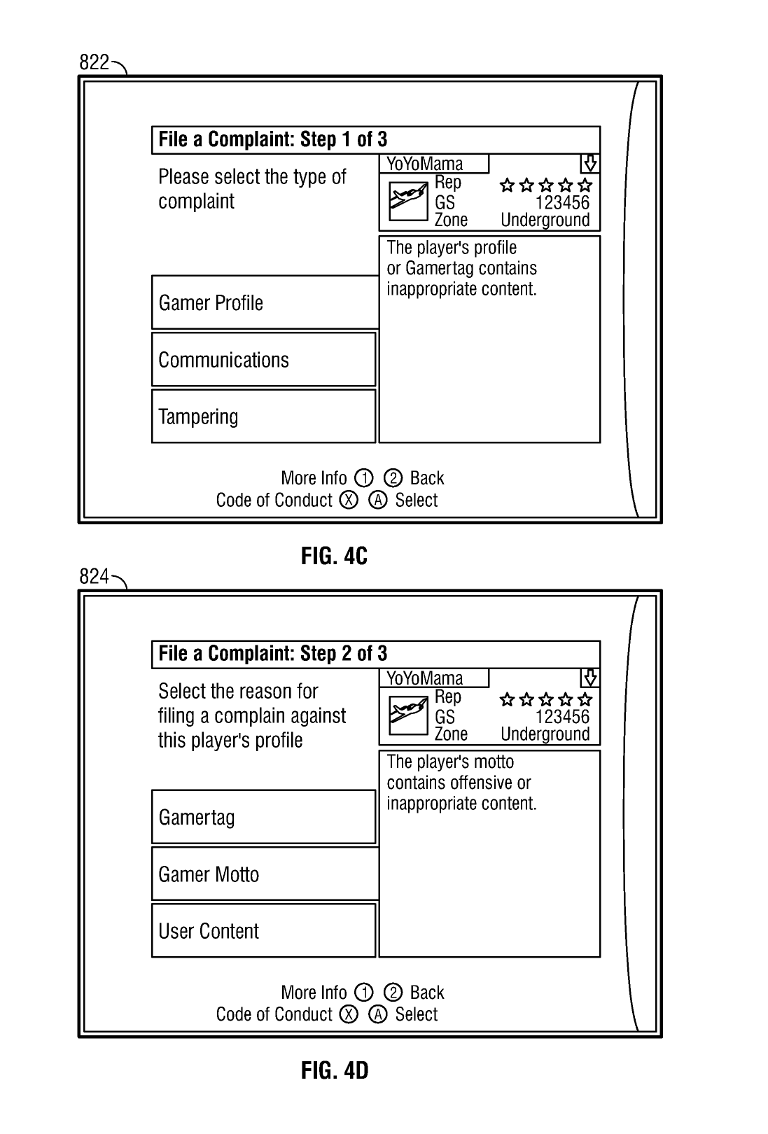

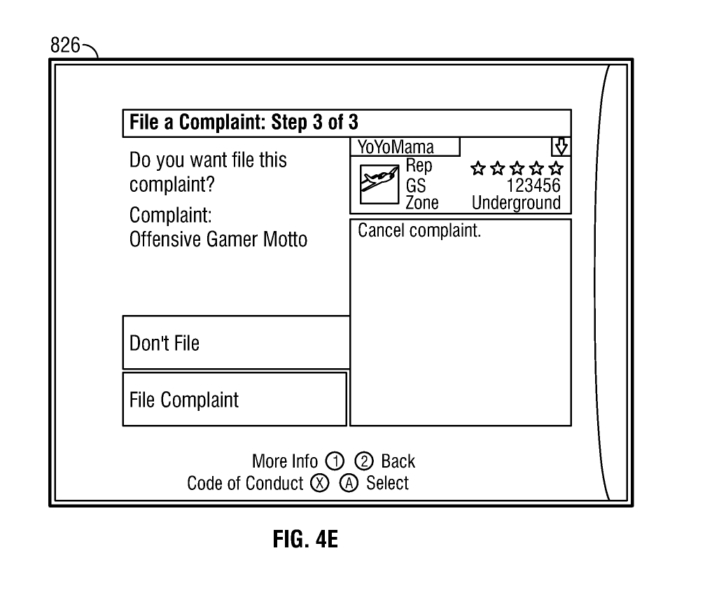

Enforcement of the code of conduct often occurs in response to a complaint filed by one user against another user. For instance, when a player has joined a game with another player, the service determines that the two players have come together in a session and may offer the user the opportunity to provide feedback on the other user from the game. FIGS. 4A-4E illustrate one example of a user interface (UI) for a feedback mechanism whereby a game player can provide feedback on other game players. In this example the feedback mechanism also offers the user an opportunity to file a complaint. For instance, FIG. 4A illustrates a UI wherein the user is offered the opportunity to select the Player Review button 803 or the File Complaints button 804. If the complaint button is selected then the UI illustrated in FIG. 4B is provided. In FIG. 8B, the feedback provider has selected the complaint button 804 and proceeded directly to filing a complaint by way of screen 820. In FIG. 4C, the feedback provider is asked to select a category of complaint to be filed as shown in screen 822. The feedback provider is asked to provide a specific reason for the complaint. FIG. 4D illustrates a screen 824 that presents options from which a user may choose, specifying reasons for filing the complaint. Finally in the screen 826 of FIG. 4E, confirmation of the complaint filing is provided. While the example above allows the user to file a complaint as part of a feedback process, in other implementations the user may be allowed to file a complaint through one or more different UIs that may or may not be part of a larger feedback process. While in the example shown above a complaint is filed by a user who has played a match against another user, in some cases a user may file a complaint against another even if the two users have not previously played a game with one another or even interacted with one another on the service.

Unfortunately, it can difficult to verify the accuracy of a complaint and thus it can be difficult to determine when it is appropriate to enforce the code of conduct by penalizing the user, typically by suspending them from using some or all of the available services for a limited period of time. Service providers are naturally reluctant to penalize users since they are generally paying customers of their service and thus only want to enforce complaints that are in fact accurate.

The accuracy of some types of complaints can be more difficult to verify than others. This may be particularly true when the complaint is a communication complaint based on an unacceptable communication received by one user from another. This is difficult to verify because communications between users are generally conducted in a peer-to-peer manner. Consequently the service provider is not able to access the communication in order to verify it.

To address this verification problem and to better automate the enforcement process, it has been shown to be helpful to assess the complainer's ability to accurately report unacceptable conduct (referred to herein as the “enforcement accuracy” of the complainer) as well as the likelihood that the complainant actually engaged in unacceptable conduct (“referred to herein as the “enforcement risk” of the complainant). The combination of a given user's enforcement accuracy and enforcement risk is referred to herein as the user's enforcement reputation. As explained below, an enforcement accuracy score may be assigned to reflect a user's enforcement accuracy and an enforcement risk score may be assigned to reflect a user's enforcement risk. These two scores, which respectively represent the user's “quality” as a complainer and as a target of a complaint, collectively define the user's enforcement reputation score.

A variety of different factors or parameters may be used to determine a user's enforcement reputation score. Such parameters may include, by way of example and not as a limitation on the subject matter disclosed herein, the number of incoming complaints, the number of accurate complaints, tenure on the service, the number of enforcement actions taken against a user, the number of complaints a user files, the number of complaints that a user files that result in enforcement actions, the number of offensive words used by a user in communications with other users, etc.

Particularly useful parameters are those which cannot be easily manipulated by users. For example, the number of complaints filed against a given user is easily manipulated since a coordinated campaign can be organized against that user. Thus, this parameter by itself does not necessarily accurately reflect the likelihood that the user has in fact committed an infraction of the code of conduct.

By way of example, parameters that are not easily manipulated may include certain actions taken by one user against another during the course of a game session, an example of which is the number of mutes and block executed by a user against another user. A mute refers to an action by one user in which the user prevents receipt of all audio communication from another user and a block refers to action by one user in which the user prevents receipt of all communications (e.g., audio, video, pictures, messages, etc). These two parameters are not easily manipulated because the user issuing a mute or block generally does not have any expectation that these actions will result in any type of enforcement action being taken against the complainant. Rather, the user is simply using them to reduce or eliminate communications from the complainant. Accordingly, the mute and block parameters may be strong indicators of unacceptable conduct on the part of a user and thus may be important parameters used in determining a user's enforcement risk score.

The aforementioned parameters may be assigned different weights when using them to develop an enforcement accuracy score and an enforcement risk score. For instance, more weight may be assigned to complaints received in the immediate past several days or weeks than to complaints received from earlier periods of time while also giving less weight to complaints received as part of a coordinated campaign against the user (i.e., “spam complaints”). In addition, as mentioned above, the mute and block parameters may be important parameters used in determining a user's enforcement risk score and thus they may be more heavily weighted when calculating this score. Moreover, since a block is a more severe action than a mute, in some cases a block may be given more weight than a mute.

The number of previous enforcement actions taken against a complainant may also serve as a weighted parameter that can be used to amplify a current suspicion of unacceptable conduct. That is, the likelihood that a complaint is accurate may be in part based upon previous enforcement actions taken against the complainant. In some cases different weights may be assigned to different types of enforcement actions. For example, a service suspension (prohibiting the user from using all available services for a period of time) may be given more or less weight than a communication suspension (prohibiting the user from communicating with other users while still allowing the user to participate in game sessions). For instance, if the complaint that the service is attempting to verify is a communication complaint, then recent communication suspensions may be given more weight than service suspensions.

In some embodiments, the parameters used to determine a user's enforcement reputation scores are decayed (weighted as a function of time) to provide a more temporally accurate determination of the user's enforcement reputation. Parameter values may be decayed as additional game sessions are conducted. The chronological passage of time alone does not necessarily decay a parameter. Rather, decayed parameters may include, by way of example, the total number of strangers encountered by a user, the total number of people who prefer playing with the user and the total number of people who prefer to avoid playing with the user. Decaying parameters used to determine a user's enforcement reputation provides a means for a user to change his/her enforcement reputation as additional games are played.

Once a user's enforcement accuracy and risk assessment scores are determined they may be used to decide whether to take an enforcement action against the user in response to receipt of one or more complaints. In one implementation a threshold may be established and users with scores exceeding the threshold may be subject to an enforcement action while those below the threshold are not subject to an enforcement action. The threshold may be established empirically, for example, using an existing dataset.

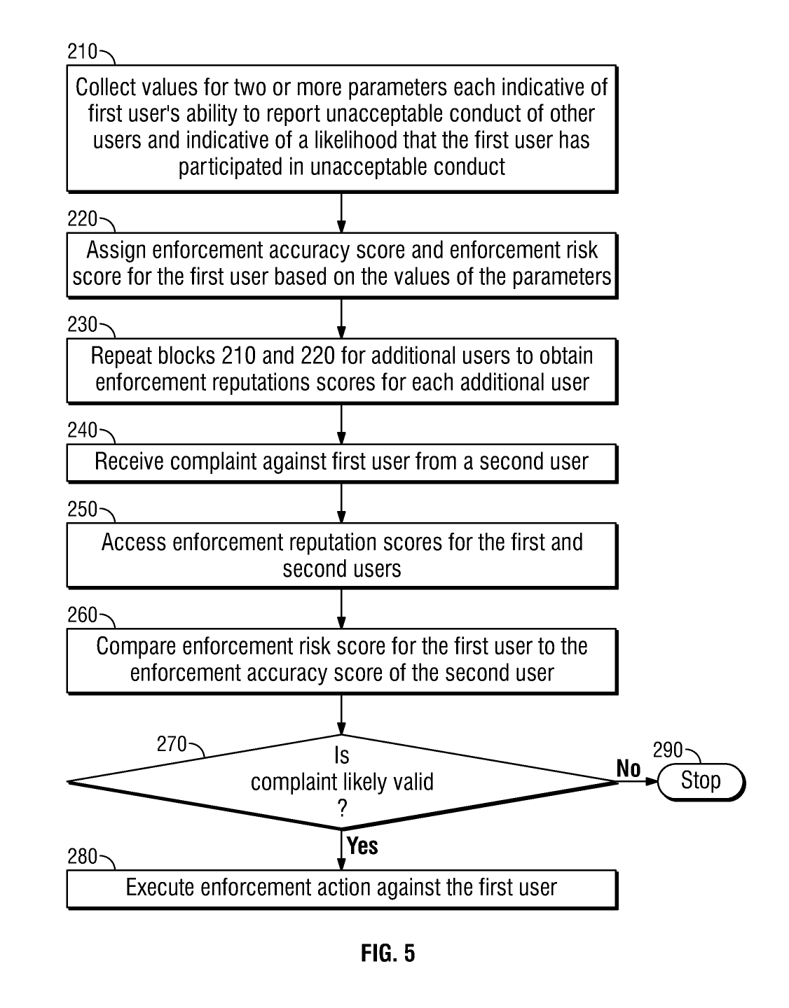

FIG. 5 is a flowchart illustrating one example of a method of determining an enforcement reputation score for users of a multi-player computer-based game and using that score to respond to a complaint submitted against a first user by another user. The method begins at block 210 when the service associated with the game collects values for two or more parameters each indicative of the first user's ability to report unacceptable conduct of other users who have participated in one or more game sessions with the first user and indicative of a likelihood that the first user has participated in unacceptable conduct. Examples of such parameters have been discussed above. Next, at block 220, an enforcement accuracy score and an enforcement risk score for the first user is assigned based on the values of the parameters collected for the first user. The combination of the two scores results in an enforcement reputation score.

Blocks 210 and 220 are repeated for additional users at block 430 to obtain enforcement reputations scores for each additional user.

At some subsequent time a complaint against the first user may be received by the service from a second user at block 240. In response to receipt of the complaint, at block 250 the service accesses the enforcement reputation scores for each of the users from a database. The complaint may specify, for example, that the first user has been a participant in unacceptable communication with the complainer. At decision block 260 the service compares the enforcement risk score for the first user to the enforcement accuracy score of the second user. Based on the comparison, the service determines at decision block 270 if the complaint submitted against the first user by the second user has merit. If the complaint is deemed valid, then the service executes an enforcement action against the first user at block 280. Otherwise the process ends at block 290 or flags the account for further review/monitoring.

The claimed subject matter may be implemented as a method, apparatus, or article of manufacture using standard programming and/or engineering techniques to produce software, firmware, hardware, or any combination thereof to control a computer to implement the disclosed subject matter. For instance, the claimed subject matter may be implemented as a computer-readable storage medium embedded with a computer executable program, which encompasses a computer program accessible from any computer-readable storage device or storage media. For example, computer readable storage media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). However, computer readable storage media do not include transitory forms of storage such as propagating signals, for example. Of course, those skilled in the art will recognize many modifications may be made to this configuration without departing from the scope or spirit of the claimed subject matter.

Although the subject matter has been described in language specific to structural features and/or methodological acts, it is to be understood that the subject matter defined in the appended claims is not necessarily limited to the specific features or acts described above. Rather, the specific features and acts described.

1. A method of determining an enforcement reputation of a first user of a multi-player computer-based game, comprising:
(i) collecting values for a plurality of parameters each indicative of a first user's ability to report unacceptable conduct of other users who have participated in one or more game sessions with the first user or indicative of a likelihood that the first user has participated in unacceptable conduct; and
(ii) assigning an enforcement accuracy score and an enforcement risk score to the first user based on the values of the plurality of parameters collected for the first user, the enforcement accuracy score reflecting the first user's ability to report unacceptable conduct of the other users and the enforcement risk score reflecting the likelihood that the first user has participated in unacceptable conduct.

2. The method of claim 1 in which the plurality of parameters includes a mute parameter and a block parameter.

3. The method of claim 1 in which the plurality of parameters is selected from the group consisting of a number of incoming complaints against a user, a number of accurate complaints against a user, tenure of a user on the computer-based game, a number of enforcement actions taken against a user, a number of complaints a user files against another user, a number of complaints that a user files that result in enforcement actions and a number of offensive words used by a user in communications with other users.

4. The method of claim 1 further comprising:
repeating steps (i) and (ii) for a second user to obtain an enforcement accuracy score and an enforcement risk score for the second user;
receiving a complaint filed against the first user by the second user; and
determining if the complaint is likely valid based on at least one of the enforcement risk score or enforcement accuracy score for the first user and on at least one of the enforcement risk score or enforcement accuracy score for the second user.

5. The method of claim 4 in which determining that the complaint is likely valid includes comparing the enforcement risk score of the first user to the enforcement accuracy score of the second user.

6. The method of claim 5 further comprising obtaining an overall score based on the comparison, wherein an overall score greater than a threshold value indicates that the complaint is likely valid and an overall score less than the threshold value indicates that the complaint is likely not valid.

7. The method of claim 1 further comprising weighting the values for the plurality of parameters prior to assigning the enforcement accuracy scores and the enforcement risk scores.

8. The method of claim 7 in which the plurality of parameters includes a mute parameter and a block parameter, the values for the mute and block parameters being weighted more heavily than values for other parameters included in the plurality of parameters.

9. The method of claim 8 in which the value for the block parameter is weighted more heavily than the value for the mute parameter.

10. The method of claim 1 wherein the unacceptable conduct is communication between the first user and one or more of the other users.

11. One or more computer-readable storage media containing instructions which, when executed by one or more processors perform a method of responding to a complaint submitted against a first user of a multi-player computer-based game by a second user, comprising:
receiving a complaint submitted against the first user by the second user;
accessing enforcement reputation scores for each of the first and second users, each enforcement reputation score including an enforcement accuracy score and an enforcement risk score for the respective user, the enforcement accuracy score reflecting the respective user's ability to report unacceptable conduct of other users and the enforcement risk score reflecting the likelihood that the respective user has participated in unacceptable conduct; and
treating the complaint submitted against the first user by the second user as valid based on the enforcement reputation scores for the first and second users.

12. The computer-readable storage media of claim 11 further comprising further reviewing/monitoring the first user or executing an enforcement action against the first user if the complaint is treated as valid.

13. The computer-readable storage media of claim 12 wherein the enforcement action includes a suspension of one or more services available to the first user by a service provider providing the computer-based game.

14. The computer-readable storage media of claim 11 wherein the enforcement reputation score is assigned to the first user based on values for a plurality of parameters each indicative of the first user's ability to report unacceptable conduct of other users who have participated in one or more game sessions with the first user and indicative of a likelihood that the first user has participated in unacceptable conduct.

15. The computer-readable storage media of claim 14 in which the plurality of parameters includes a mute parameter and a block parameter.

16. The computer-readable storage media of claim 14 in which the plurality of parameters is selected from the group consisting of a number of incoming complaints against a user, a number of accurate complaints against a user, tenure of a user on the computer-based game, a number of enforcement actions taken against a user, a number of complaints a user files against another user, a number of complaints that a user files that result in enforcement actions and a number of offensive words used by a user in communications with other users.

17. The computer-readable storage media of claim 11 in which treating the complaint as likely valid includes comparing the enforcement risk score of the first user to the enforcement accuracy score of the second user.

18. The computer-readable storage media of claim 14 further comprising weighting the values for the plurality of parameters prior to assigning the enforcement accuracy scores and the enforcement risk scores.

19. The computer-readable storage media of claim 18 in which the plurality of parameters includes a mute parameter and a block parameter.

20. A system for determining a reputation of a gamer of a multi-player computer-based game, said system comprising:
a database server for storing values for a plurality of parameters each indicative of enforcement reputation scores for each of a plurality of users, each enforcement reputation score including an enforcement accuracy score and an enforcement risk score for the respective user, the enforcement accuracy score reflecting the respective user's ability to report unacceptable conduct of other users and the enforcement risk score reflecting the likelihood that the respective user has participated in unacceptable conduct
a service for:
accessing said database;
receiving a complaint filed against a first of the users by a second of the users;
determining the enforcement reputation scores for the first and second users based on the stored values for the plurality of parameters for the first and second users; and
treating the complaint submitted against the first user by the second user as valid based on the enforcement reputation scores for the first and second users.
